(19) United States
(12) Patent Application Publication
(10) Pub. No.: US 2018/0105331 A1
(43) Pub. Date: Apr. 19, 2018

(54) BEVERAGE TOPPER

(71) Applicant: Jose Aceves Guzman, Antioch, CA (US)

(72) Inventor: Jose Aceves Guzman, Antioch, CA (US)

(21) Appl. No.: 15/293,849

(22) Filed: Oct. 14, 2016

(51) Int. Cl. B65D 47/06; A23L 2/56

(52) U.S. Cl. CPC B65D 47/06; A23V 2002/00; A23L 2/56

(57) ABSTRACT

A beverage topper can include a sleeve with connecting features for connecting the beverage topper with the top of a beverage container, such as a bottle. Beverage toppers can further include a porous reservoir therein for permitting a user to pass the liquid from the beverage container through a seasoning, such as salt, contained in the reservoir by tilting the beverage container.

### BACKGROUND OF THE INVENTION

In Mexico and in the United States Southwest, a favorite pastime is consuming cold, refreshing beer on the beach. In one tradition, TECATÉ (beer), consumed from a can, is improved by the addition of rock salt to the rim of the can. Lemon is generally dripped on the rock salt, which stays on the rim of the can, and allows the user to enjoy sips of the refreshing drink with the flavor of salt and citrus.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments herein disclosed relate to beverage toppers. A beverage topper can be formed of a sleeve having a top and a bottom, and having connecting features arranged at the bottom for connecting the sleeve with a top of a beverage container in a liquid-tight manner. The sleeve has a reservoir, which can be substantially interior to the sleeve, or may in some other cases hang from the sleeve; and the sleeve and the reservoir are arranged to provide a channel around the reservoir and inside the sleeve for a liquid, such as beer, to pass from the bottom of the sleeve and out the top of the sleeve when the beverage topper is connected with the beverage container and when the beverage container is inverted.

Beverage toppers can have various connecting features arranged at the bottom and sized to connect with a beer bottle top around an opening of the beer bottle. Alternatively, connecting features can be configured and/or sized to connect with a beer can, with a threaded bottle, or other container. Some connecting features may flexibly expand and close around a top of the beverage container. The sleeve may also include slots arranged around a perimeter of the bottom to allow the bottom to flexibly snap around the top of the beverage container, or the beverage topper can be formed of, or include, a pliable material at the bottom configured to deform around a top of the beverage container. Connecting features may also include a surface coating, such as a soft, pliable, and/or smooth material for sealing the bottom of the beverage topper to the top of the beverage container.

A beverage topper can include supports connecting the reservoir with the sleeve. The reservoir may be suspended substantially centrally within the sleeve, or may be offset. The reservoir can be suspended such that it remains above the top of the beverage container when the beverage topper is attached with the beverage container, or the reservoir may be suspended so that a portion of the reservoir is suspended inside the beverage container.

The reservoir is configured to retain a quantity of seasoning, such as a rock salt, compressed salt solid, salt flakes, or other form of salt. In some cases, the salt is included within the reservoir. The reservoir may have a top that encloses the salt therein. The reservoir may be porous, e.g., as a basket or mesh, and may be substantially closed such that the quantity of salt is trapped by the reservoir. The salt may, in some cases, also be infused with a flavoring.

Alternatively, the reservoir can be a channel connected with an interior surface of the sleeve. In some cases, the reservoir may include a ring within the sleeve and defining an opening through a center of the sleeve. In some other cases, the reservoir may include a shelf interior to the sleeve, the shelf defining a partial circular shape with a first side defined by a first portion of the interior wall of the sleeve, and a second side of the shelf defining an opening through the sleeve.

For a fuller understanding of the nature and advantages of the present invention, reference should be made to the ensuing detailed description and accompanying drawings.

### BRIEF DESCRIPTION OF THE DRAWINGS

Various embodiments in accordance with the present disclosure will be described with reference to the drawings, in which:

FIG. 1 is a side section schematic illustrating a beverage topper aligned with a beverage container;

FIG. 2 is a partial side section schematic illustrating the beverage topper of FIG. 1 mated with the beverage container shown in FIG. 1;

FIG. 3 is a top view illustrating the beverage topper of FIG. 1;

FIG. 4 is a side section schematic illustrating a second beverage topper;

FIG. 5 is a top view illustrating the beverage topper of FIG. 4;

FIG. 6 is a side section schematic illustrating a third beverage topper;

FIG. 7 is a top view illustrating the beverage topper of FIG. 6;

FIG. 8 is a side section schematic illustrating a fourth beverage topper aligned with another beverage container;

FIG. 9 is a side section schematic illustrating a fifth beverage topper aligned with the beverage container shown in FIG. 8;

FIG. 10 is a side section schematic illustrating a sixth beverage topper aligned with a third beverage container; and

FIG. 11 is a side section schematic illustrating a seventh beverage topper aligned with the beverage container of FIG. 1.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Devices described herein include devices for facilitating the addition of seasoning, such as salt and/or flavoring to a beverage. Embodiments herein are particularly directed to beverage toppers, i.e. structures that attach with a top of a beverage container, which have a reservoir for containing salt and/or other flavoring substances. By way of example, and as described in further detail below, a beverage topper can be affixed to the top of a container such as a beer bottle, screw-top beer bottle, beer can, or comparable container. The beverage topper can have connecting features which affix the beverage topper with the container, so that liquid from the container can pour out through the beverage topper without spilling from the interface between the two. The liquid from the container can pass through or around the reservoir to pick up flavoring from salt and/or any other suitable flavoring substance disposed therein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

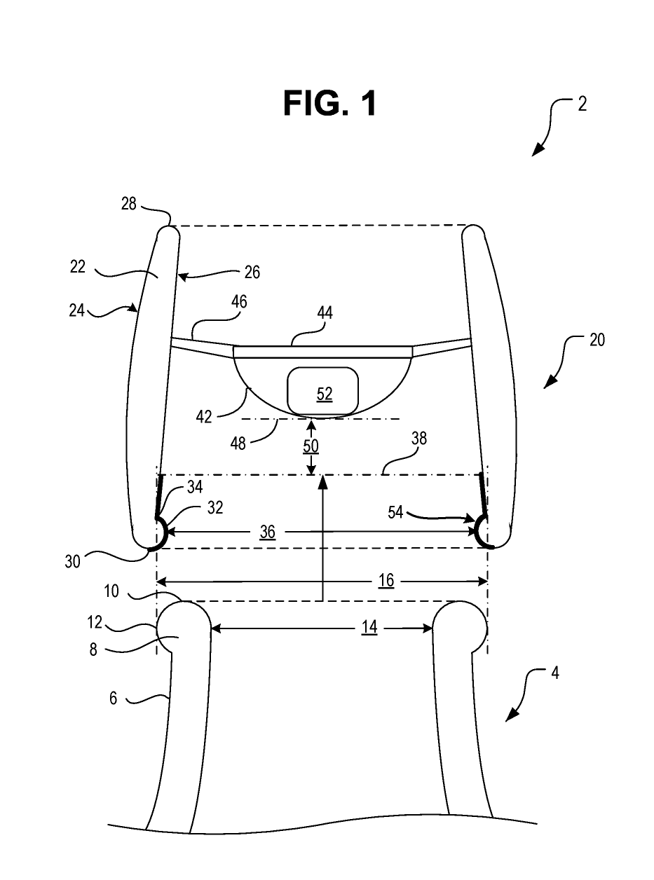

Referring now to the drawings, in which like reference numerals represent like parts throughout the several views, FIG. 1 illustrates an example of an assembly 2 of a beverage topper 20 aligned with a beverage container 4, in accordance with embodiments. Dimensions of the beverage topper 20 may be described with reference to dimensions of the beverage container 4. The beverage container 4 can include a beer bottle or any comparable container. The beverage container 4 includes walls 6 and an opening 8. The opening has a top 10 and outer sides 12 that extend beyond the walls 6 to an outer diameter 16 that is greater than the inner diameter 14.

The beverage topper 20 includes a hollow sleeve 22 which may be cylindrical, substantially cylindrical, or angled. The sleeve 22 has an outer surface 24 and an inner surface 26 that defines a liquid conduit or channel therethrough. The sleeve 22 also has a top 28 and a bottom 30, defining openings through the sleeve.

Between the top 28 and bottom 30, the sleeve 22 contains supports 46 connecting the sleeve with a seasoning reservoir 42. The seasoning reservoir 42 can be any suitable container for retaining a quantity of seasoning 52, such as salt, a salt mixture, a salt tablet containing added flavoring, or any suitable alternative seasoning that adds flavor to a beverage. The seasoning reservoir may be, for example, a mesh basket (e.g., a metal mesh, a plastic mesh, fabric or fibrous mesh, or similar), or a solid container having pores therethrough, such as a plastic or metal reservoir with at least one hole for fluid to pass through. The reservoir 42 can have a reservoir top 44 which may enclose the quantity of seasoning 52. In some cases, the reservoir top 44 can be opened and closed by a user, such that a user can place the quantity of seasoning 52 within the reservoir 42 and secure it therein by closing the reservoir top 44. In some cases, the beverage topper 20 may be prepackaged including the quantity of seasoning 52 within the reservoir 42. The reservoir 42 also defines a reservoir bottom 48 comprising a lowest extent of the reservoir. The reservoir top 44 may also be porous so that a liquid can pass therethrough. In some cases, the reservoir top 44 can be arranged to receive a flavoring, such as a citrus flavoring or citrus juice, for distributing the flavoring onto the quantity of seasoning 52.

At the bottom 30 of the sleeve 22, the beverage topper 20 includes connecting features configured to retain the bottle top 8. The connecting features can include, for example, an inner flange 32 projecting inward from the inner walls 26 of the sleeve 22 and a pocket 34 positioned above the inner flange. The pocket 34 and inner walls 26 define an upper travel 38 which comprises the uppermost extent that the bottle 4 can travel into the beverage topper. The pocket 34 may also include an indentation (not shown) into the inner walls 26, or may in some cases be formed of an indentation rather than the flange 32. Preferably, the outer diameter 16 of the beverage container 4 is slightly larger than an enclosed diameter 36 of the flange 32. When the beverage topper 20 is pressed onto the beverage container 4, the sleeve 22 can deform slightly so that the bottle opening 8 comes to rest proximate to the pocket 34. The beverage container top 10 has a maximum travel 38 within the beverage topper 20 that falls short of the reservoir bottom 48 by at least a short distance 50, so that the reservoir 42 does not obstruct the passage of fluid out of the beverage container opening 8. In some cases, the distance 50 may be less than 1 cm, but in other cases may be 1-2 cm or more than 2 cm.

The flange 32 and/or pocket 34 can be covered by a surface coating 54 which facilitates connecting the beverage topper 20 with the beverage container 4. The surface coating 54 can include a low-friction surface such as a polymer coating (e.g., a fluoropolymer coating like PTFE or comparable), or a pliable, flexible, and/or slightly compressible coating (e.g., a rubber or soft polymer or comparable) that deforms around the beverage container opening 8 when the beverage container 4 is inserted in the beverage topper 20.

The quantity of seasoning 52 can take a variety for forms. Preferably, the quantity of seasoning 52 is of a form that can dissolve gradually with exposure to a liquid through the reservoir 42. For example, the quantity of seasoning 52 may be one or more pieces of rock salt, one or more compressed salt solids (e.g., salt blocks), a collection of salt flakes, or comparable salt element or collection of salt elements. The quantity of seasoning 52 can include one or more flavorings, which may include natural and/or artificial flavorings, imbued therein. For example, a quantity of seasoning 52 can include a lemon, lemon/lime, or other citrus flavoring infused therein.

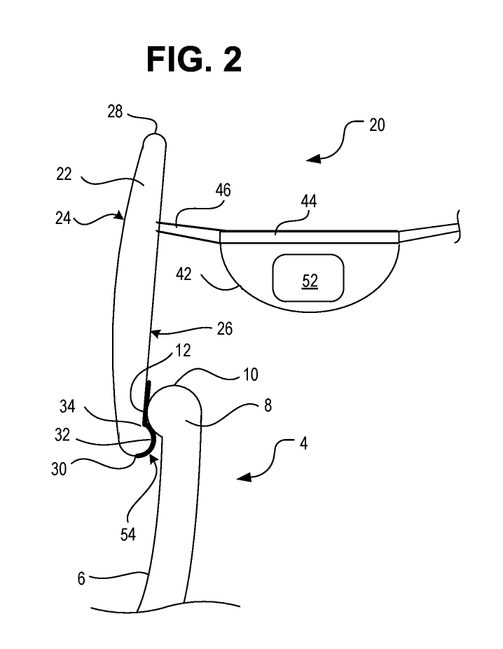

FIG. 2 is a partial side section schematic illustrating the beverage topper 20 of FIG. 1 mated with the beverage container 4 shown in FIG. 1, in accordance with embodiments. In this view, the positioning of the beverage container opening 8 with respect to the pocket 34 and flange 32 is more clearly shown. The surface coating 54 is shown disposed between the beverage container opening 8 and the pocket 34, although in practice, the surface coating 54 may be compressed.

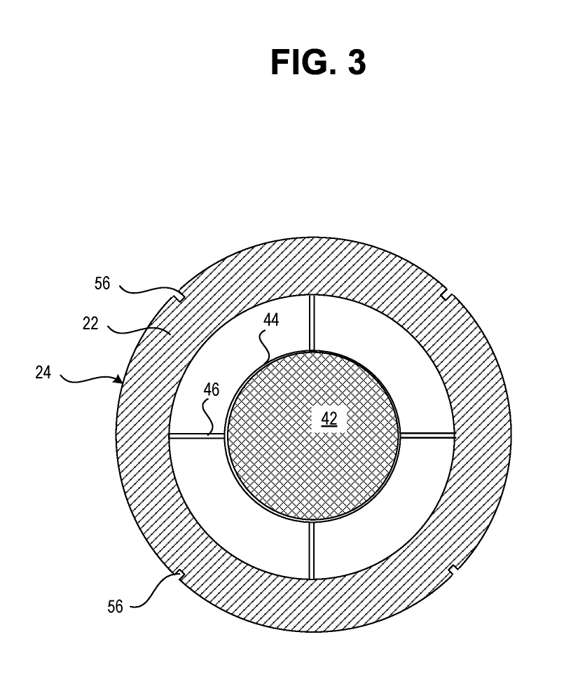

FIG. 3 is a top view illustrating the beverage topper 20 of FIG. 1. In this view, several optional slots 56 are shown, which can help to facilitate flexure of the sleeve 22 in order to allow the sleeve to snap into place on a beverage container. The slots 56 are preferably smaller than the upper travel 38 of the beverage container opening 8 (FIG. 1) so that, when the beverage topper 20 is attached with the beverage container 4, no liquid escapes through the slots.

In use, the beverage topper 20 can be attached with the beverage container 4 by affixing the beverage topper to the opening 8. The beverage topper 20 can be snap-fit, rotated, press-fit, or otherwise manually worked to attach with the beverage container 4. Once attached, the beverage topper 20 creates a liquid tight coupling with the opening so that fluid can flow from the beverage container 4 to the top of the beverage topper 20 without leaking at the connection of the beverage topper 20 to the opening 8. The seasoning 52 may be included in the reservoir 42 or may be added by a user prior to or after attachment of the beverage topper 20 with the beverage container 4. To use the beverage topper 20, a user can incline the assembly 2 of the beverage container 4 and beverage topper, and drink the contained beverage as it passes through the liquid conduit formed by the inner surface 26, past and/or through at least part of the seasoning reservoir 42 containing seasoning 52, and out of the beverage topper via the upper opening defined by the top 28 of the beverage topper. Further embodiments described below can be used in a similar manner.

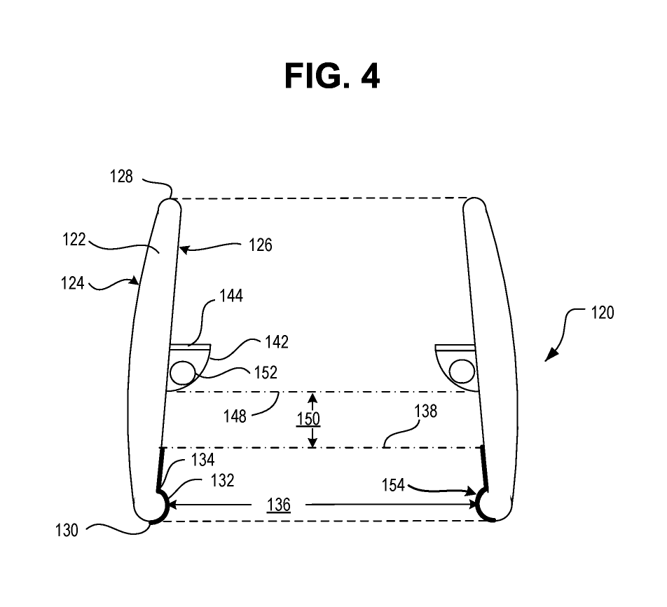

FIG. 4 is a side section schematic illustrating a second example of a beverage topper 120, in accordance with embodiments. The embodiments described in FIG. 4, and further embodiments below, contain similar reference numerals denoting similar parts, with the addition of a digit denoting the new embodiment, e.g., beverage topper 20 of FIG. 1 is similar in function to beverage topper 120 of FIG. 4. The beverage topper 120 includes a sleeve 122 similar to the sleeve 22 of the beverage topper 22 show in FIG. 1. The sleeve 122 has a top 128 and a bottom 130. The sleeve can be substantially cylindrical having an outer wall 124 and an inner wall 126, but may conform to other suitable shapes.

At the bottom 130 of the beverage topper 120, the inner wall 126 has connecting features include an interior flange 132 that projects inward and a pocket 134 arranged and sized to capture a top of a beverage container (not shown). The interior flange 132 has an inner diameter 136 sized to interfere with an opening of a beverage container, so that the beverage container is securely held by the pocket 134 when inserted therein. A surface coating 154 may be applied to the interior flange 132 and/or pocket 134 for engaging a beverage container, similar to the coating 54 described above with reference to FIG. 1.

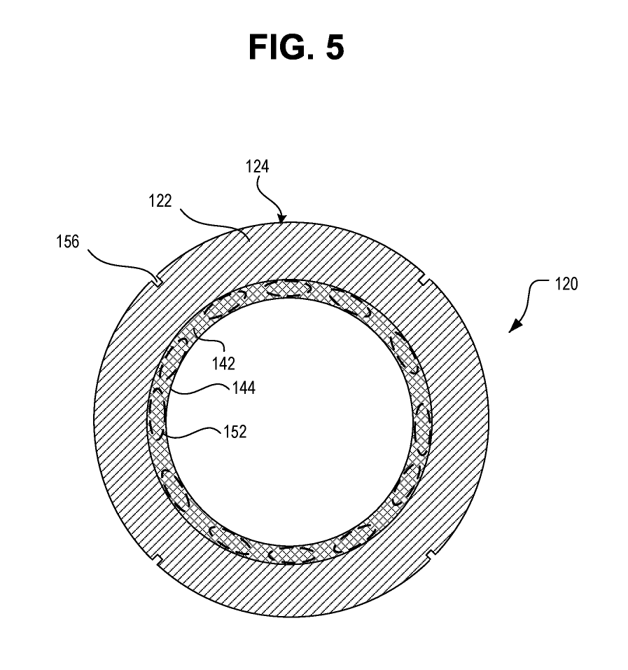

A seasoning reservoir 142 is disposed against the inner wall 126 in a configuration like a circular channel connected with the inner wall. The seasoning reservoir 142 can follow an entire circumference of the inner wall 126 (see also, FIG. 5), or may in some cases follow a partial circumference of the inner wall. The seasoning reservoir 142 can include a top 144 that secures a quantity of seasoning 152 therein. The seasoning reservoir 142 preferably has a bottom 148 that is above the upper travel 138 of a beverage container, so that the seasoning reservoir 142 does not interfere with the beverage container when it is inserted in the beverage topper 120. The seasoning reservoir 142 and upper travel 138 are separated by a distance 150 which may be, for example, less than 1 cm, between 1-2 cm, or more than 2 cm. The quantity of seasoning 152 may be arranged as a series of pellets or salt solids within the seasoning reservoir 142.

FIG. 5 is a top view illustrating the beverage topper 120 of FIG. 4. In this view, the positioning of the seasoning reservoir 142 with respect to the sleeve 122 is more readily apparent. As shown, the seasoning reservoir 142 is interior to the sleeve 122, and contains the quantity of seasoning 152 therein. The quantity of seasoning 152 can be enclosed in the reservoir 142 by the reservoir top 144. The outer wall 124 of the sleeve 122 may be broken by optional slots 156 that better enable the sleeve 122 to flex when placed over a beverage container in order to snap into place.

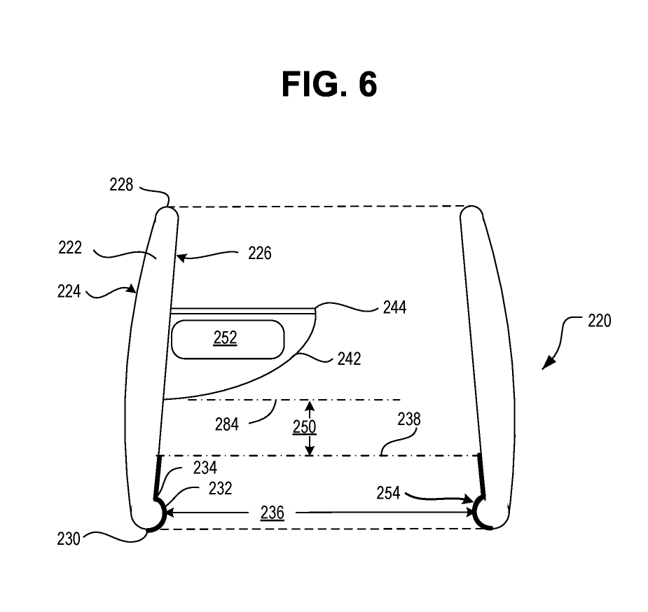

FIG. 6 is a side section schematic illustrating a third example of a beverage topper 220, in accordance with embodiments. The beverage topper 220, similar to the beverage toppers 20 and 120 (FIGS. 1-5) has a sleeve 222 with an inner surface 226 and an outer surface 224, the sleeve configured to snap to the top of a beverage container such as a bottle. The sleeve 222 can have a top 228 and a bottom 230. In some cases, the sleeve 222 can be substantially cylindrical. The bottom 230 can include retention features including, e.g., an interior flange 232 and pocket 234; and the interior flange and pocket may be additionally coated with a surface coating 254 for sealing the beverage topper 220 to a beverage container. Similar surface coatings are described above with reference to FIGS. 1-5 (e.g., coatings 54 and 154). The beverage topper is sized to accommodate a beverage container up to an upper travel 238.

A seasoning reservoir 242 is disposed in the beverage topper 220 extending from a side of the interior surface 226 a distance 250 above the upper travel 238. The distance 250 may be less than 1 cm, but in other cases may be 1-2 cm or more than 2 cm. At any rate, the distance 250 is generally arranged to be sufficient that the seasoning reservoir 242 is unable to obstruct either a top of a beverage container disposed in the beverage topper or a flow of liquid from the beverage container. The seasoning reservoir 242 is able to contain a quantity of seasoning 252, which may be enclosed in the seasoning reservoir 242 by a top 244. The seasoning reservoir may be any suitable construction, as described above with reference to the seasoning reservoirs 42, 142 described above in FIGS. 1-5.

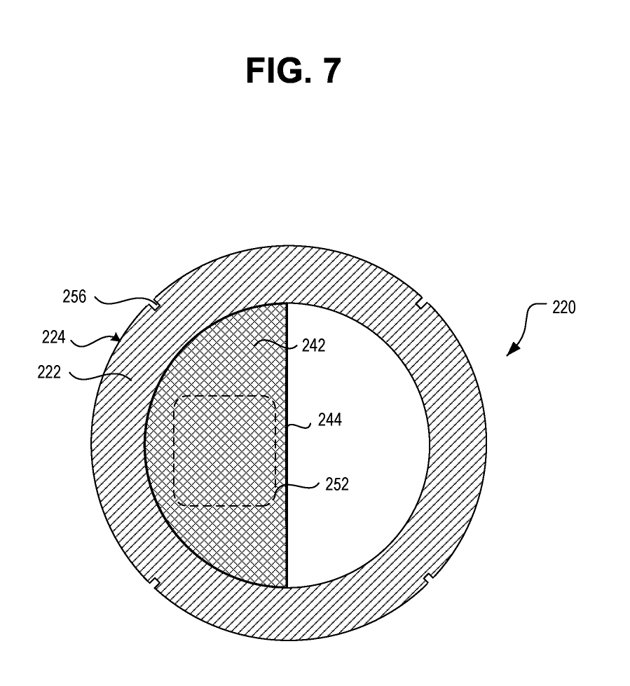

FIG. 7 is a top view illustrating the beverage topper 220 of FIG. 6, more clearly showing the positioning of the seasoning reservoir 242 within the sleeve 222. The seasoning reservoir 242 extends from the sleeve to cover a portion, e.g., approximately half, of a cross sectional area interior to the sleeve 222, and may be covered by a top 244. By covering a portion of the interior of the sleeve 222, the seasoning reservoir 242 may be put into a liquid stream, or removed from a liquid stream, of a user of the beverage topper 220 by rotating an attached beverage container while drinking therefrom. This action would permit a user to vary whether a sip of a beverage is passed over the quantity of seasoning 252 or not on a sip-by-sip basis.

In various alternative embodiments, the exact portion covered by the seasoning reservoir 242 may vary, e.g., between ⅛, ¼, or ¾ of the cross sectional area. In some alternative embodiments, the seasoning reservoir 242 may be readily porous and cover the entire cross sectional area, such that all of the liquid pouring from a connected bottle would pass through the seasoning reservoir.

Similar to examples discussed above, the outer surface 224 of the sleeve 222 may include optional grooves or slots 256. Slots 256 may improve the ability of the sleeve 222 to deform slightly to snap over a top of a beverage container.

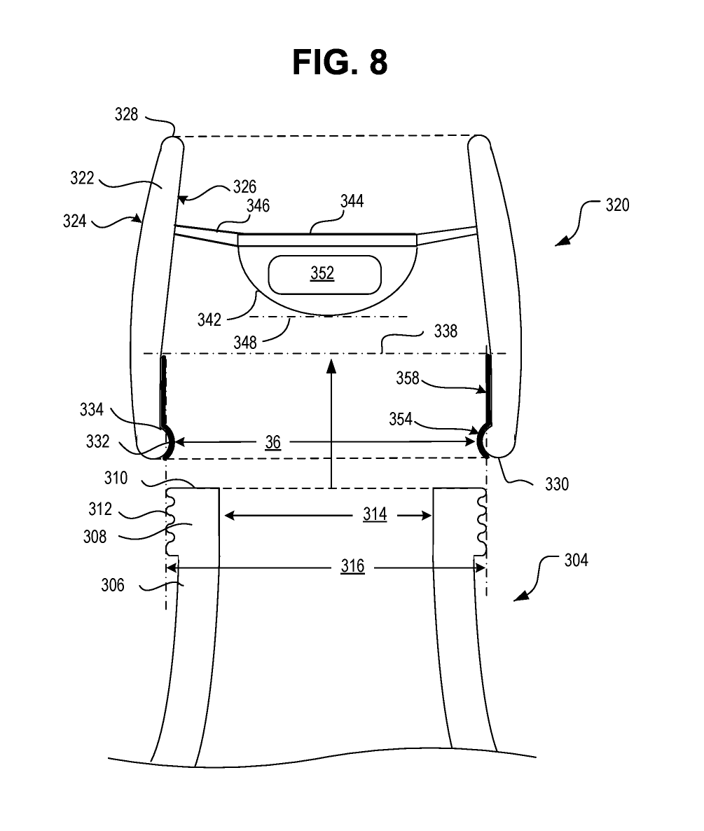

FIG. 8 is a side section schematic illustrating a fourth beverage topper 320 aligned with another beverage container, in accordance with embodiments. The beverage topper 320 is similar in form to the beverage topper 20 shown in FIGS. 1-3, with the addition of an elongate pocket 334 which may more readily accept certain types of beverage containers, e.g., thread-top bottles. For example, in a thread-top bottle 304, a series of threads 312 may be disposed outside a rim 308 between the top 310 and sides 306 of the bottle. The threads have an outer extent 316 and the bottle 304 has an inner diameter 314.

The beverage topper 320 can accommodate the thread-top bottle 304 by providing, at the bottom 330, retention features including an interior flange 332 and an elongate pocket 334. The retention features can be coated with interior coatings 354, 358 which can accommodate the threads 312. In particular, an upper interior coating 358 lining the elongate pocket 334 can include a pliable material, such as a rubber or soft polymer that grips the threads 312, preventing leakage. The elongate pocket 334 can be sized to accommodate the outer extent 316 of the threads 312, and the interior flange 332 can be sized to capture the threads, i.e. slightly smaller in diameter.

The beverage topper 320 can be otherwise similar to any of the previously disclosed beverage toppers 20, 120, 220 (FIGS. 1-7). For example, the beverage topper 320 includes a sleeve 322 with an outer surface 324 and inner surface 326, and a top 328. A seasoning reservoir 342 can be disposed interior to the sleeve 322, with a lower extent 348 positioned above an upper travel 338 of a beverage container 304. The seasoning reservoir 342 is configured to contain a quantity of seasoning 352, and may be enclosed with a seasoning reservoir top 344. In the example shown, the seasoning reservoir 342 is connected with the inner surface 326 by a series of supports 346. In alternative embodiments, the seasoning reservoir 342 may be disposed directly against the inner surface 326.

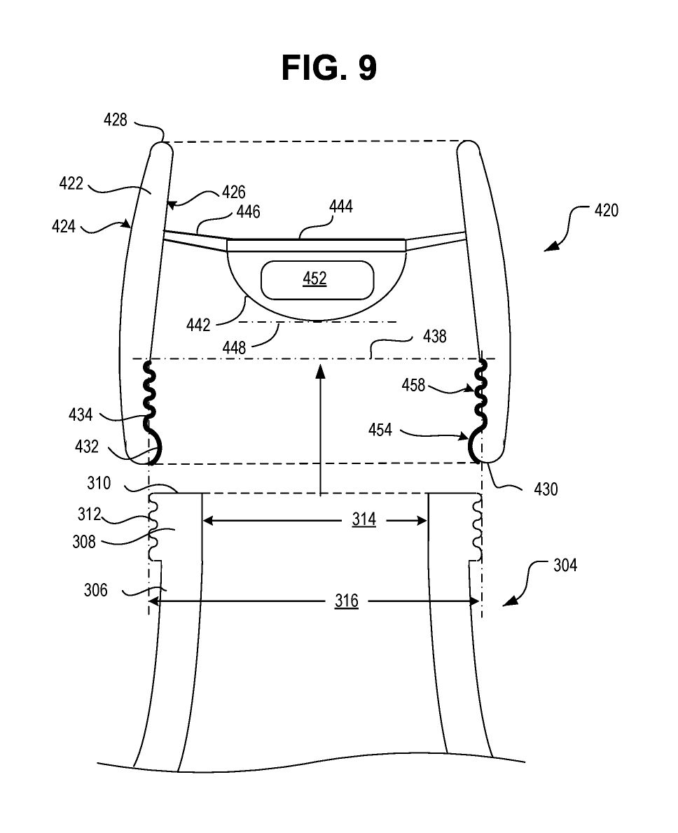

FIG. 9 is a side section schematic illustrating a fifth example of a beverage topper 420 aligned with the beverage container 304 shown in FIG. 8. The beverage topper 420 is similar to the beverage topper 320 shown in FIG. 8, including additional features for connecting the beverage topper with the beverage container 304. For example, the beverage topper 420 includes a bottom 430 with attachment features including an inner flange 432 and a threaded pocket 434, which is preferably arranged to align with and connect with threads 312 of the beverage container 304. The threaded pocket 434 and inner flange 432 can be sized similar to the pocket 334 and flange 334 shown in FIG. 8, with the additional feature that the threaded pocket 434 can contain threads that match conventional threaded designs of a thread-top bottle.

As with the beverage topper 320 described in FIG. 8, the beverage topper 420 can include similar features as the other beverage toppers disclosed herein, such as a sleeve 422 with inner and outer surfaces 426, 424 and top 428, and a seasoning reservoir 442 disposed therein for containing the quantity of seasoning 452. The seasoning reservoir 442 has a lower extent 448 located preferably above an upper travel 438 of the beverage container 304, and may be covered with a top 444. As shown, the seasoning reservoir 442 is connected with the inner surface 426 by a series of supports 446; but in some cases, the seasoning reservoir 442 may be connected directly with the inner surface 426.

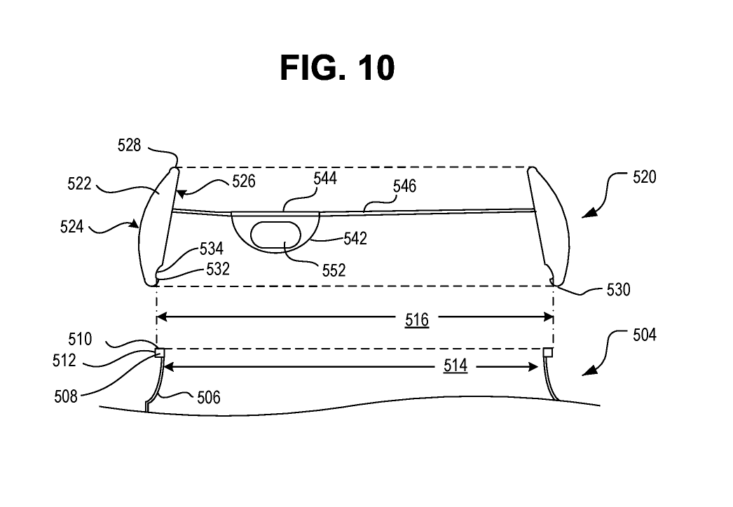

FIG. 10 is a side section schematic illustrating a sixth example of a beverage topper 520 aligned with a third beverage container 504, in accordance with embodiments. In general, embodiments disclosed above have been directed toward connecting a beverage topper with a top of a bottle, such as a conventional glass bottle. However, the principles applied above may be applied with a wide-mouth bottle or with a can, such as the beverage container 504. The beverage container 504 has a top 508 with a top surface 510 and a flange 512, above a sidewall 506, with a wide inner diameter 514 defined by the top 508 and an outer diameter 516 defined by the flange 512. The beverage topper 520 can be defined by a sleeve 522 with an inner surface 526 and outer surface 524, a top 528, and a bottom 530, with retention features disposed in the inner surface near the bottom. For example, retention features can include a pocket 534 for receiving the beverage container flange 512 of the beverage container 504 and an inner flange 532 for snapping over the beverage container flange. In some cases, the pocket 534 is sized to receive a standard aluminum can or similar container.

A seasoning reservoir 542 can be disposed interior to the sleeve 522 for containing a quantity of seasoning 552. The seasoning reservoir 542 may be constructed in a similar fashion to any previously disclosed seasoning reservoir, e.g., with porous, semi-porous, mesh, or comparable materials for holding a sold solid while allowing liquid to flow therethrough. The seasoning reservoir 542 can be connected with the inner surface 526 by supports 546. In some cases, the supports 546 may hold the seasoning reservoir 542 in an offset position, e.g., off-center in the sleeve 522 so that a user can pour the liquid from the beverage container 504 therethrough while drinking. In alternative embodiments, the seasoning reservoir 542 may be positioned or attached directly adjacent a portion of the inner surface 526.

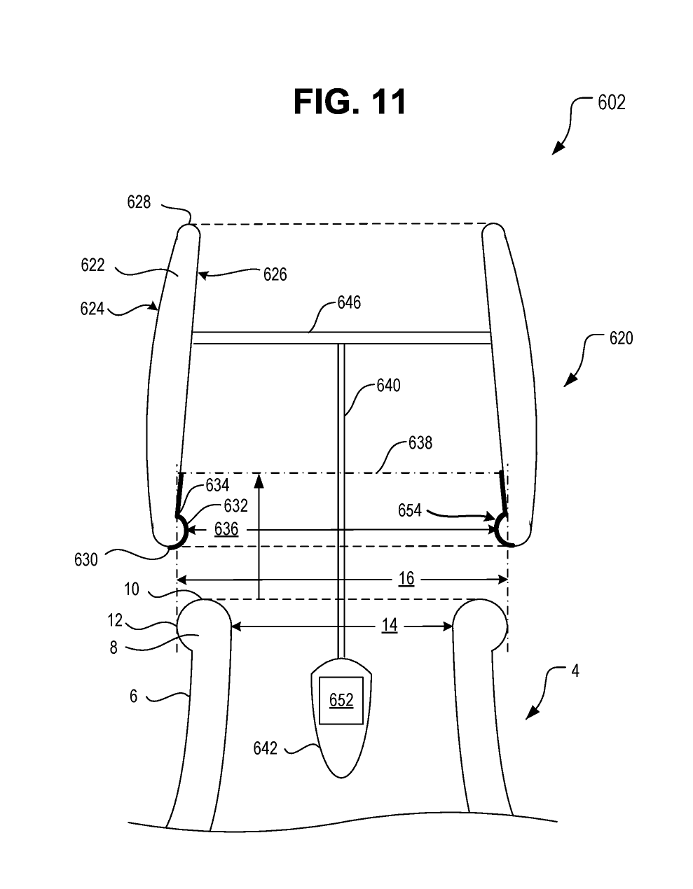

FIG. 11 is a side section schematic illustrating a seventh example of a beverage topper 620 aligned with the beverage container of FIG. 1, in accordance with embodiments. The beverage topper 620 is similar in many respects to other beverage toppers herein disclosed, but shows an alternative seasoning reservoir 642 which may be disposed within the opening 8 of the beverage container 4.

For example, the beverage topper 620 can include a sleeve 622 with outer and inner surfaces 624, 626, a top 628, and a bottom 630. Retention features such as a flange 632, pocket 634, and surface coating 654 may be disposed along the inner surface 626 near the bottom 630 for retaining the beverage container 4. Support features 646 may be positioned in the beverage topper 620 above an upper travel 638 of the beverage container 4, extending from the inner surface 626. The support features 626 can support an elongate support 640 that extends the seasoning reservoir 642 into the opening 8 of the beverage container 4. In some cases, the elongate support 620 can be non-rigid, e.g., a string, plastic cord, or similar. The seasoning reservoir 642 can be arranged to rest just inside the beverage container 4 when the beverage topper 620 is attached with the beverage container, such that a user can pass liquid through the seasoning reservoir 642 by tipping the beverage container attached thereto.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A beverage topper, comprising:
a sleeve, the sleeve having a top and a bottom, and having connecting features arranged at the bottom for connecting the sleeve in a liquid-tight manner with a top of a beverage container; and
a reservoir connected with the sleeve, wherein the sleeve and the reservoir are arranged to provide a channel inside the sleeve for a liquid to pass from the bottom of the sleeve and out the top of the sleeve, and for the liquid to pass through at least part of the reservoir, when the beverage topper is connected with the beverage container and when the beverage container is inverted.

2. The beverage topper of claim 1, wherein the connecting features arranged at the bottom are sized to connect with a beer bottle top around an opening of the beer bottle.

3. The beverage topper of claim 1, wherein the connecting features arranged at the bottom are sized to connect with a beer can around an opening of the beer can.

4. The beverage topper of claim 1, wherein the connecting features are configured to flexibly expand and close around a top of the beverage container.

5. The beverage topper of claim 4, wherein the connecting features further comprise slots arranged around a perimeter of the bottom to allow the bottom to flexibly snap around the top of the beverage container.

6. The beverage topper of claim 1, wherein the connecting features comprise a pliable material configured to deform around a top of the beverage container.

7. The beverage topper of claim 1, wherein the connecting features comprise threads configured to interact with a top of the beverage container.

8. The beverage topper of claim 1, wherein the reservoir is suspended substantially centrally within the sleeve.

9. The beverage topper of claim 1, wherein the reservoir is suspended within the sleeve above the connecting features such that, when the sleeve is connected with the top of the beverage container, the reservoir is suspended above the top of the beverage container.

10. The beverage topper of claim 1, wherein the reservoir is suspended within the sleeve such that, when the sleeve is connected with the top of the beverage container, a portion of the reservoir is suspended inside the beverage container.

11. The beverage topper of claim 1, further comprising:
a quantity of salt, the quantity of salt being disposed in the reservoir.

12. The beverage topper of claim 11, wherein the reservoir is porous and substantially closed such that the quantity of salt is trapped by the reservoir.

13. The beverage topper of claim 11, wherein the salt comprises salt infused with a flavoring.

14. The beverage topper of claim 11, wherein the salt comprises a compressed salt solid.

15. The beverage topper of claim 11, wherein:
the reservoir comprises openings; and
the salt comprises a collection of salt flakes, at least some of the collection being larger than the openings of the reservoir.

16. The beverage topper of claim 1, wherein the reservoir comprises a mesh.

17. The beverage topper of claim 1, wherein the reservoir is suspended from a flexible member such that, when the when the sleeve is connected with the top of the beverage container, the reservoir is suspended at least partly inside the beverage container.

18. The beverage topper of claim 1, wherein the reservoir comprises a circular channel disposed in a ring interior to the sleeve, the ring being concentric with the sleeve and defining an opening through a center of the sleeve.

19. The beverage topper of claim 1, wherein the reservoir comprises a shelf interior to the sleeve, the shelf defining a partial circular shape with a first side defined by a first portion of the interior wall of the sleeve, wherein a second side of the shelf and a second portion of the interior wall of the sleeve define an opening through the sleeve.

20. A method, comprising:
installing a beverage topper over an opening of a beverage container in a liquid-tight manner, the beverage topper comprising a liquid conduit having a bottom that installs over the opening and an upper opening removed from the bottom, the beverage topper including a reservoir affixed within the liquid conduit of the beverage topper, the reservoir containing a seasoning that adds flavor to the beverage; and
inverting the beverage container with the installed beverage topper such that a beverage in the beverage container is passed through the liquid conduit of the beverage container, through at least a portion of the seasoning reservoir, and out of the upper opening of beverage container.
